(19) United States
(12) Patent Application Publication
(10) Pub. No.: US 2013/0163778 A1
(43) Pub. Date: Jun. 27, 2013

(54) SOUND OUTPUT DEVICE

(71) Applicants: Takayuki ITO, Nagoya-shi (JP); Shigeru TASHIRO, Toyokawa-shi (JP); Hiroaki UMEMOTO, Neyagawa-shi (JP)

(72) Inventors: Takayuki ITO, Nagoya-shi (JP); Shigeru TASHIRO, Toyokawa-shi (JP); Hiroaki UMEMOTO, Neyagawa-shi (JP)

(21) Appl. No.: 13/717,567

(22) Filed: Dec. 17, 2012

(30) Foreign Application Priority Data
Dec. 26, 2011 (JP) 2011-282599

(51) Int. Cl. G10K 11/175

(52) U.S. Cl. CPC G10K 11/175
USPC 381/73.1

(57) ABSTRACT

A sound output device for masking an operation sound generated by equipment, having: a BGM output unit that outputs a BGM; and a masking sound output unit that outputs a masking sound after the BGM output unit outputs the BGM.

### CROSS-REFERENCE TO RELATED APPLICATION

This application is based on Japanese Patent Application No. 2011-282599 filed on Dec. 26, 2011, the content of which is incorporated herein by reference.

### BACKGROUND OF THE INVENTION

1. Field of the Invention

The present invention relates to a sound output device that outputs a masker (masking sound) for masking noise generated by equipment.

2. Description of Related Art

Conventionally, to deal with noise generated by, for example, an image forming apparatus or suchlike, a so-called “noise reduction technology” for reducing operation sounds themselves is employed. Noise reduction lowers the sound pressure level of operation sounds, but does not completely solve problems of “harshness” and “discomfort” caused by operation sounds.

Aside from the noise reduction technology, there has also been proposed a sound masking technology as a technology to lower noise (to a less perceptible level). Sound masking is a method taking advantage of a phenomenon (sound masking effect) in which perception of a sound at a certain level makes other sounds barely audible, and this method is mainly classified into frequency masking and temporal masking. More specifically, noise is superimposed with a sound (masker or masking sound) mainly similar in frequency band to the noise, so that the noise is made barely audible, thereby reducing harshness and discomfort.

As a conventional sound output device applying the sound masking technology, there is a noise masking device described in Japanese Patent Laid-Open Publication No. 9-193506. This noise masking device is provided in an image forming apparatus or suchlike with a drive mechanism generating a loud sound (noise) during operation, and the noise masking device includes a sound generator for generating a masking sound to mask the loud sound, and a masking sound control unit for controlling the sound generator to generate a masking sound within a frequency range including the main component frequency of the loud sound. The masking sound control unit allows the masking sound to be generated within a frequency range between the lower and upper limits of a critical frequency band for the main component frequency of the loud sound.

However, there is a problem where the masking sound resembles noise in terms of frequency characteristic, and is often an unfamiliar sound to the user, so that when the noise masking device outputs the masking sound, the user may perceive the sound to be annoying.

### SUMMARY OF THE INVENTION

In a first embodiment of the present invention, a sound output device for masking an operation sound generated by equipment includes: a BGM output unit that outputs a BGM; and a masking sound output unit that outputs a masking sound after the BGM output unit outputs the BGM.

In a second embodiment of the present invention, a sound output device for masking an operation sound generated by equipment includes: a first masking sound output unit that outputs a temporal masking sound; and a second masking sound output unit that outputs a frequency masking sound after the first masking sound output unit outputs the temporal masking sound.

### BRIEF DESCRIPTION OF THE DRAWINGS

FIG. 1 is a block diagram illustrating the configuration of a sound output device according to a first embodiment of the present invention;

FIG. 2 is a graph showing the basic concept of masking;

FIG. 3 is a graph illustrating exemplary changes in output sound pressure level of a BGM and a masking sound during a sequential operation of an image forming apparatus;

FIG. 4 is a graph showing the timing of outputting a masking sound and the degree of change in output volume of the masking sound, both of which are changed in accordance with the time to start recording medium supply;

FIG. 5 is a graph illustrating other exemplary changes in output sound pressure level of the BGM and the masking sound during the sequential operation of the image forming apparatus; and

FIG. 6 is a block diagram illustrating the configuration of a sound output device according to a second embodiment of the present invention.

### DETAILED DESCRIPTION OF THE PREFERRED EMBODIMENTS

### Regarding Image Forming Apparatus

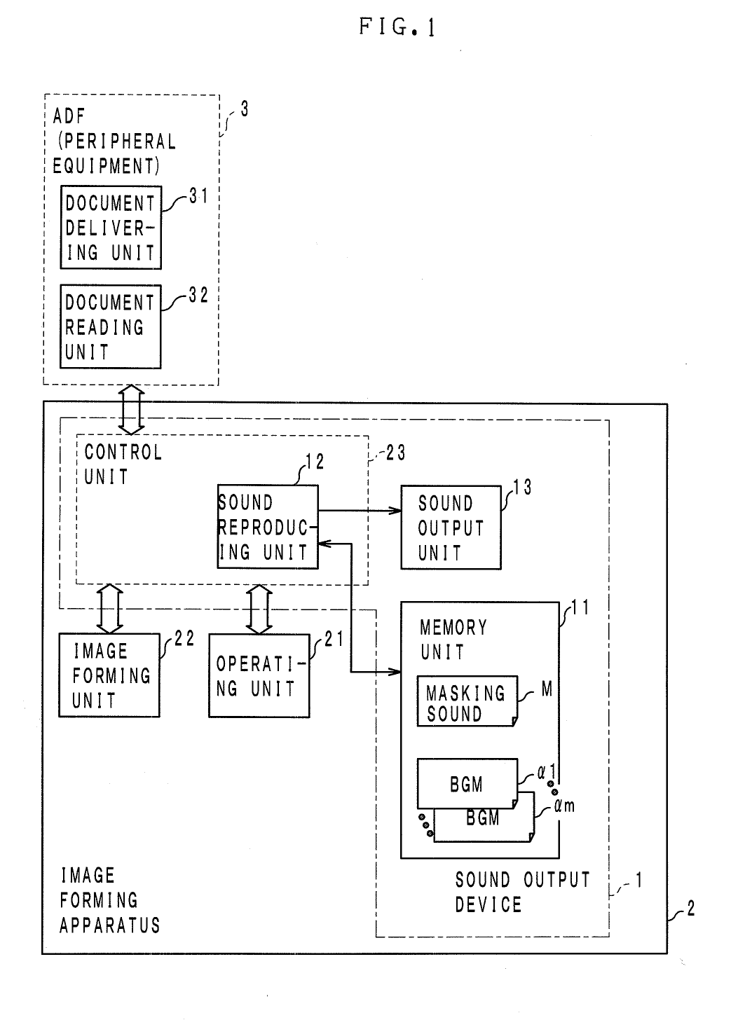

Before describing sound output devices according to first and second embodiments of the present invention, an image forming apparatus 2 will be described as an example of the equipment in which the sound output device is provided. In FIG. 1, the image forming apparatus 2 is, for example, a multifunction peripheral, color printer, or suchlike, employing electrophotography with a tandem system, and generally includes an operating unit 21, an image forming unit 22, and a control unit 23.

The operating unit 21 is typically provided on the upper front of the image forming apparatus 2, and includes operating buttons to be pressed by the user. A typical exemplary operating button or suchlike is a print start button for the user to instruct the image forming apparatus 2 to start printing. The operating unit 21 transmits a print start command to the control unit 23 in accordance with the user's operation.

In the image forming unit 22, a circumferential surface of a photoreceptor drum is charged by a charger, and thereafter irradiated by an optical system with an optical beam modulated with image data. As a result, an electrostatic latent image is formed on the circumferential surface of the photoreceptor drum. Here, the image data is transmitted from, for example, a document reading unit 32 (to be described later) or a personal computer (not shown) connected to the image forming apparatus 2. Moreover, in the image forming unit 22, a developer supplies toner to the circumferential surface of the photoreceptor drum on which the electrostatic latent image is formed, thereby creating a toner image on the circumferential surface of the photoreceptor drum. In the image forming unit 22, a primary-transfer roller transfers the toner image on the circumferential surface of the photoreceptor drum to a transfer belt. The toner image is created for each of the colors of, for example, yellow (Y), magenta (M), cyan (C), and black (K). Such toner images are transferred onto one another on the transfer belt, so that a combined toner image is supported.

Furthermore, the image forming unit 22 receives a recording medium (e.g., paper) delivered from a supply tray (not shown). In the image forming unit 22, a secondary-transfer roller transfers the combined toner image on the transfer belt to the delivered recording medium. A fusing device heats and presses the recording medium fed from the secondary-transfer roller, thereby fixing the combined toner image onto the recording medium. The recording medium subjected to the fixing process is ejected and placed onto an output tray via an ejection roller of the image forming apparatus 2.

The control unit 23 includes a CPU and main memory, and operates in accordance with a program stored in the main memory, thereby controlling the operation of components of the image forming unit 22 and peripheral equipment. In a specific example, the control unit 23 provides control signals to, for example, motors (not shown) for driving the components of the image forming unit 22.

### Regarding Peripheral Equipment of Image Forming Apparatus

Next, the peripheral equipment of the image forming apparatus 2 will be described. In the present embodiment, an automatic document feeder (ADF) 3 is described as an example of the peripheral equipment. The ADF 3 is provided on the image forming apparatus 2, and generally includes a document delivering unit 31 and a document reading unit 32. Under control of the control unit 23, the document delivering unit 31 delivers an image document placed on a tray of the ADF 3 to the document reading unit 32. The document reading unit 32 is an optical scanner, which reads the image document fed from the document delivering unit 31, generates image data represented by the three primary colors red (R), green (G), and blue (B), and transmits the data to the control unit 23 in the image forming apparatus 2. This RGB image data is converted by the control unit 23 into YMCK image data.

### First Embodiment

Next, a sound output device 1 according to the first embodiment will be described. The sound output device 1 is provided in the image forming apparatus 2, and includes a memory unit 11, a sound reproducing unit 12 incorporated in the control unit 23 in the form of, for example, software, and a sound output unit 13 acting as an example of a BGM output unit or a masking sound output unit. Note that in the present embodiment, the sound output device 1 is described as being provided in the image forming apparatus 2, which is a printer, a copier, a fax machine, or a device incorporating such functions. However, this is not restrictive, and the sound output device 1 can be provided in any equipment that generates an operation sound.

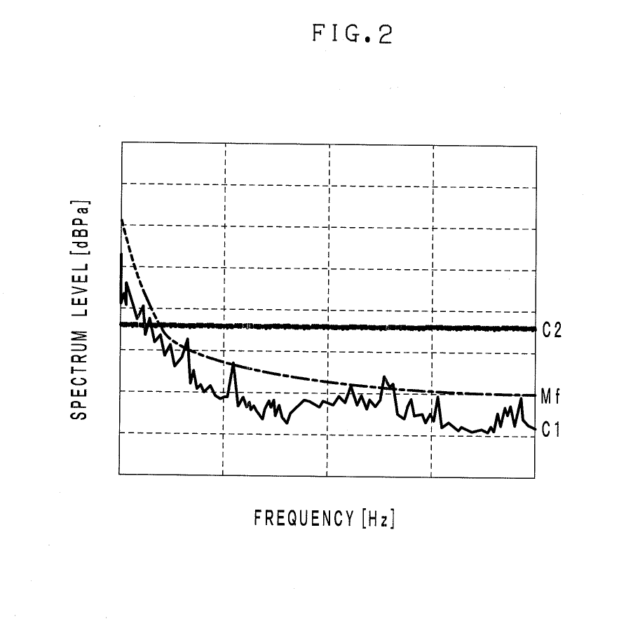

The memory unit 11 is composed of, for example, flash memory, and has stored therein data representing at least one masking sound M. The masking sound M masks an operation sound (noise) generated through a sequential operation of the image forming apparatus 2. In the present embodiment, by way of more preferred example, the masking sound M can mask an operation sound from the start of recording medium supply to the end of printing during a sequential operation of the image forming apparatus 2. In other words, the masking sound M does not mask the operation sound being produced during operation (e.g., during warm-up) before recording medium supply. Moreover, the masking sound M is a sound obtained by, for example, processing the frequency of an environmental sound or pink noise so as to have a frequency characteristic resembling that of the operation sound. Such a masking sound M is a sound that cannot be recognized by the user as machine noise and is incoherent to the user. Although the basic concept of masking is well known, it will be described in detail below with reference to FIG. 2, taking as an example the operation sound of the image forming apparatus 2.

In FIG. 2, the horizontal axis represents the frequency [Hz], and the vertical axis represents the spectrum level [dBPa]. The spectrum level is a sound pressure level for its corresponding frequency where frequency components of a sound are represented as a spectral distribution. Curve C₁ indicates a frequency characteristic of an operation sound (noise), for example, from the start of recording medium supply to the end of printing. Further, curve C₂ indicates a frequency characteristic of so-called white noise whose spectrum level is approximately constant regardless of the frequency. Furthermore, curve M_{f} indicates a frequency characteristic of a masking sound for the operation sound indicated by curve C₁.

When an operation sound is superimposed with white noise, the sound leaves harshness in the ears of an observer, and in the case where the operation sound is superimposed with a masking sound, such harshness can be significantly reduced. The masking sound can produce a masking effect if it has a higher spectrum level (sound pressure level) than the operation sound to some degree, as shown in FIG. 2.

Since the masking sound M may annoy the user, the memory unit 11 in the present embodiment has further preset therein data representing one or more than one BGMs α1 to αm (where m is a natural number of 1 or more). BGMs α₁ to αm each at least consist of rhythm and melody, and might be harmonized. Moreover, BGMs α1 to αm are not limited to music created by the human, and may be environmental sounds or nature sounds so long as the user can enjoy the sounds and understand their meanings.

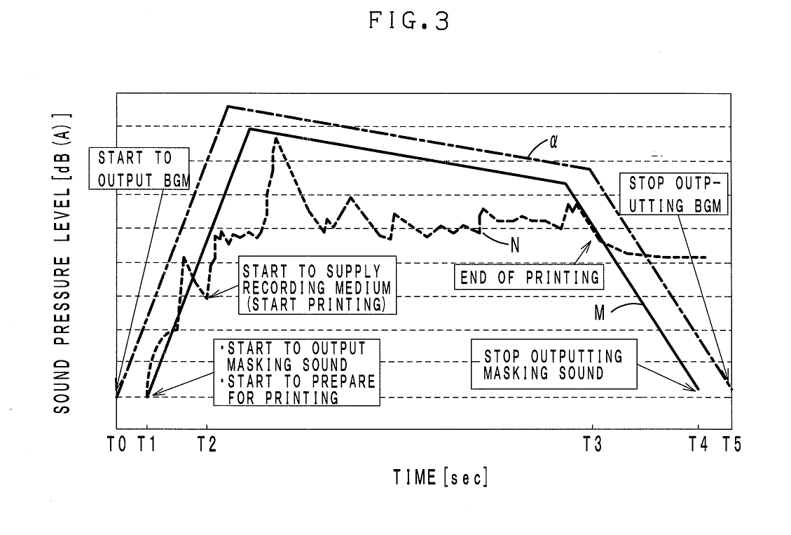

Hereinafter, referring to FIG. 3, a masking sound M and a BGM α reproduced by the sound reproducing unit 12 and outputted by the sound output unit 13 will be described with respect to examples of their changes over time.

First, curve N indicates changes of an operation sound (noise) over time while the image forming apparatus 2 prints a sheet. The control unit 23 receives image data for printing from the document reading unit 32 or an unillustrated personal computer, as described earlier. Hereinbelow, the time of image data reception is indicated by time T₀. Thereafter, the control unit 23 performs preparations for printing, including warm-up of the image forming apparatus 2, from time T₁ to time T₂. During the warm-up, the sound pressure level of the operation sound is relatively low. From time T₂, recording medium supply starts under control of the control unit 23, and after that, a series of printing processing tasks, including recording medium supply, image formation, and recording medium ejection, are performed until time T₃, so that the sound pressure level of the operation sound rises. Moreover, the sound pressure level of the operation sound burstly rises due to collision noise occasionally produced by a recording medium being delivered. After time T₃, since the printing processing has already ended, the sound pressure level of the operation sound is relatively low.

The operation sound is substantially the same before and after the image forming apparatus 2 is delivered to and actually operated by the user. Therefore, the operation sound is obtained through experiments by the supplier (manufacturer) before the image forming apparatus 2 is operated by the user, and on the basis of the obtained operation sound, the masking sound M is created and stored in the memory unit 11.

When printing a sheet, the sound reproducing unit 12 reproduces the masking sound M being read from the memory unit 11, and starts outputting the sound from the sound output unit (speaker) 14 acting as examples of a masking sound output unit, at time T₁. Here, the output sound pressure level is adjusted so as to be a prescribed initial level at time T₁ in a predetermined position around the image forming apparatus 2. This initial level is set at a relatively low sound pressure level.

The output sound pressure level of the masking sound M is adjusted so as to gradually rise after time T₁. The output sound pressure level is adjusted so as to reach a standard value in the predetermined position at time T₂. Here, the standard value is set to a sound pressure level greater than both the sound pressure level of the operation sound and the aforementioned initial level. The output sound pressure level of the masking sound M is adjusted to be greater than the sound pressure level of the operation sound thereafter until time T₃. The output sound pressure level of the masking sound M is adjusted so as to gradually fall after time T₃, and output of the masking sound stops at time T₄.

Next, the BGM α will be described. Upon the control unit 23 receives image data, the sound reproducing unit 12 starts operating. The sound reproducing unit 12 initially reads and reproduces the BGM α from the memory unit 11, and starts outputting the BGM α from the sound output unit 13 acting as an example of a BGM output unit, at time T₀, i.e., before outputting the masking sound M. The output sound pressure level of the BGM α is adjusted so as to gradually rise after time T₀. In the present embodiment, the sound output unit 13 outputs the masking sound M in combination with the BGM α from time T₁ to time T₄. In addition, the output sound pressure levels of the masking sound M and the BGM α are adjusted such that the output sound pressure level of the BGM α is higher than that of the masking sound M during the period from time T₁ to time T₄. In addition, the output sound pressure level of the BGM α is adjusted so as to gradually fall after time T₃, and output of the BGM α stops at time T₅ (i.e., after output of the masking sound stops).

### Actions and Effects of First Embodiment

As described above, in the present embodiment, the memory unit 11 has the pre-created masking sound M and BGM stored therein. Once the image forming apparatus 2 receives image data, the sound reproducing unit 12 reads the BGM α from the memory unit 11 and causes the sound output unit 13 to output the BGM α, and thereafter the sound reproducing unit 12 reads the masking sound M from the memory unit 11 and causes the sound output unit 13 to output the masking sound M. In this manner, the BGM α is outputted prior to the masking sound M being outputted, thereby drawing the user's attention to the BGM α being outputted first so that the user can perceive the masking sound outputted thereafter to be less annoying. Thus, it is possible to provide the sound output device 1 that does not cause the user to feel annoyed.

Further, the masking sound M is generated so as to mask the operation sound (noise) produced at a high sound pressure level during a predetermined action, i.e., printing processing, by the image forming apparatus 2. The masking sound M is outputted before the image forming apparatus 2 starts the printing processing. Thus, the user can be prevented from suddenly hearing both loud noise and the masking sound M, so that the user can perceive the masking sound to be much less annoying.

Further still, immediately after output of the BGM or the masking sound starts, if its output sound pressure level suddenly rises, the user perceives it to be annoying. Accordingly, in the present embodiment, the BGM or the masking sound is controlled to gradually increase in output sound pressure level after its output starts. Thus, the user can perceive the BGM or the masking sound to be less annoying.

Further yet, in the present embodiment, the sound reproducing unit 12 stops outputting the BGM α after stopping output of the masking sound M. In this manner, the masking sound M is stopped first, allowing the user to be unaware of the masking sound M. Thus, the user can be less annoyed.

Further yet, in the present embodiment, the output sound pressure level of the BGM α is higher than that of the masking sound M. Thus, the user's attention is drawn by the BGM α, so that the user can be less annoyed.

### First Modification

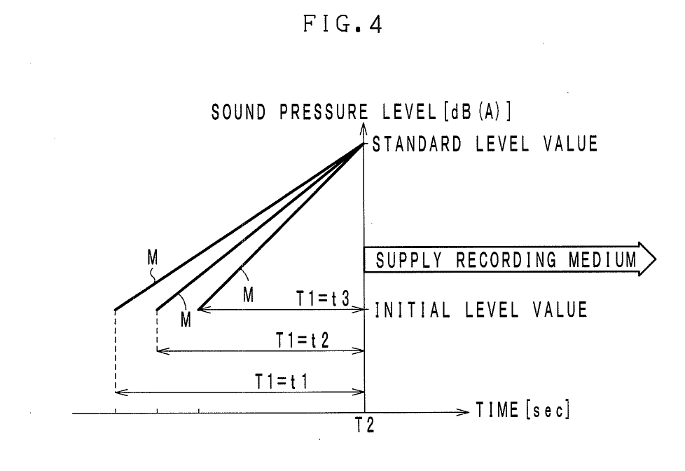

Incidentally, the image forming apparatus 2 can idle in a plurality of modes, including sleep mode, power saving mode, standby mode, etc. The time (T₂−T₁) from image data reception until the start of recording medium supply varies among the idling modes. To change the output sound pressure level of the masking sound M from the initial value to the standard value in the period from time T₁ to time T₂, as described earlier, the sound reproducing unit 12 preferably changes the timing of outputting the masking sound M, in accordance with the idling mode at the time of image data reception. For example, upon reception of image data in sleep mode, the sound reproducing unit 12 starts outputting the masking sound M some seconds t₁ before time T₂, as shown in FIG. 4. Moreover, in the case of power saving mode or standby mode, the sound reproducing unit 12 starts outputting the masking sound M some seconds t₂ or t₃ before time T₂. Here, in the present embodiment, t₁, t₂, and t₃ satisfy t₁>t₂>t₃.

In this manner, in the present modification, the timing of starting output of the masking sound M is controlled on the basis of a period of time from the image forming apparatus 2 starting operation until the start of printing processing. It is also possible to control the degree of change in the output sound pressure level of the masking sound M per unit time. As a result, for each idling mode, the masking sound M can be outputted at a suitable time or at a suitable degree of change in the output sound pressure level, thereby allowing the user to perceive the masking sound M to be less annoying. Moreover, it is desirable for the output sound pressure level of the masking sound M to rise gradually, and therefore the timing of starting output of the masking sound M is preferably advanced in accordance with a period of time up to the start of printing processing, thereby minimizing as much as possible the degree of change in the output sound pressure level of the masking sound M per unit time. Note that in the present variant, output of the BGM α may start, for example, about 0.5 seconds before output of the masking sound M starts, or output of the BGM α may start immediately after reception of image data, as described in the first embodiment.

### Second Modification

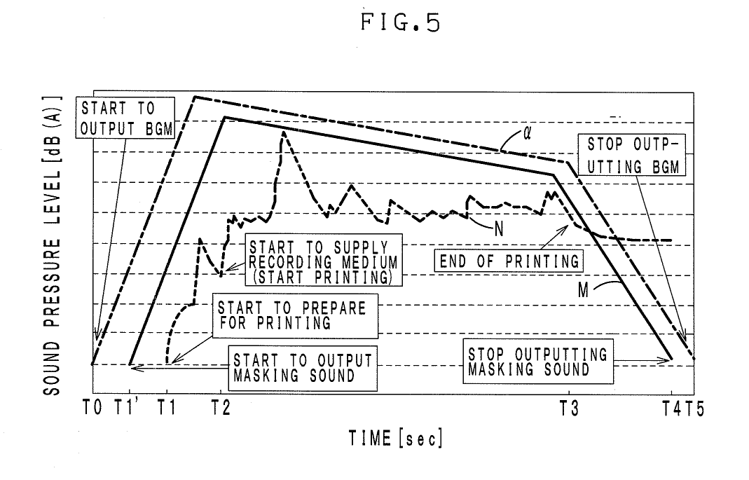

In the first modification, the timing of starting output of the masking sound M and the degree of change in the output sound pressure level of the masking sound M per unit time are adjusted for each of the idling modes. However, this is not restrictive, and, for example, the timing of starting output of the masking sound M may be fixed for any of the idling modes, as shown in FIG. 5. For example, in the example of FIG. 5, output of the BGM α starts at time T₀, and output of the masking sound M starts 0.2 seconds later at time T_{1′}. For example, the sound pressure level of the masking sound M is adjusted so as to reach the standard value at time T₂, 1.5 seconds after time T_{1′}. In this case also, the timing of starting preparations for printing and the timing of starting recording medium supply are adjusted for each idling mode, such that a masking effect can be produced at time T₂ regardless of the idling mode.

The BGM α has been described above as being outputted immediately after image data is received. However, this is not restrictive, and output of the BGM α may start, for example, when a timer reaches preset time. When the image forming apparatus 2 starts operating during the BGM α being outputted, the sound output unit 13 outputs a masking sound in a similar manner to the above.

Further, the memory unit 11 might have a plurality of BGMs α₁ to αₘ stored therein. In such a case, the sound reproducing unit 12 may read and reproduce a BGM α specified by the user operating the operating unit 21, from the memory unit 11, and may cause the sound output unit 13 to output that BGM α.

Further still, the masking sound M has been described above as masking the operation sound of the image forming apparatus 2. However, this is not restrictive, and the masking sound M may mask the operation sounds of the image forming apparatus 2 and its peripheral equipment, the ADF 3.

### Second Embodiment

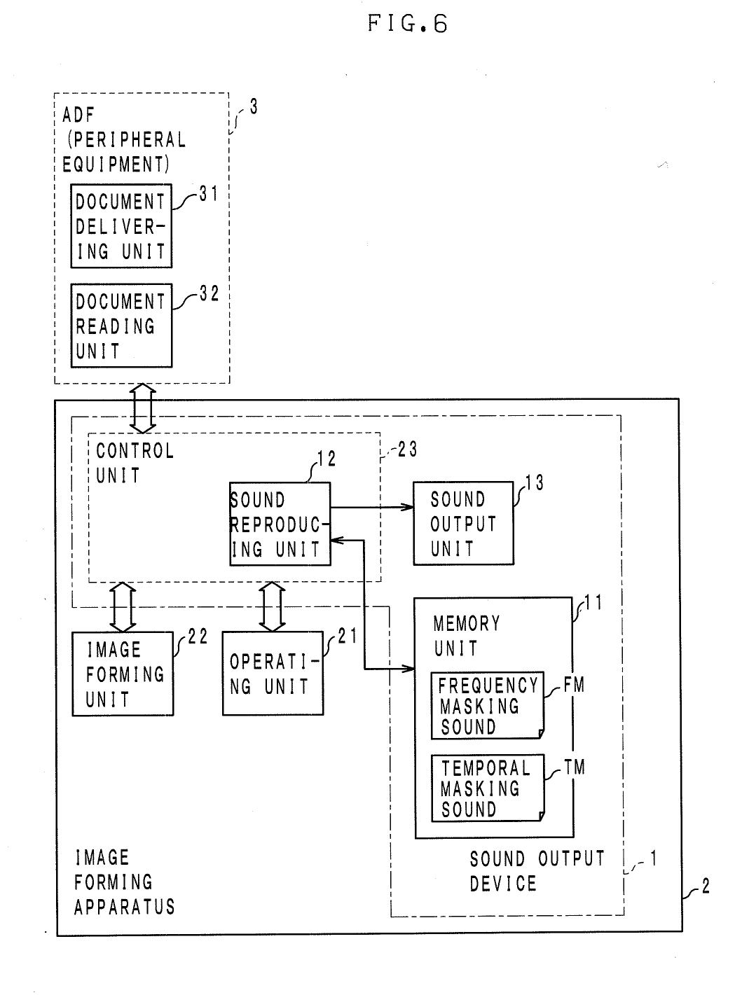

FIG. 6 illustrates the configuration of a sound output device 6 according to the second embodiment of the present invention. The sound output device 6 differs from the sound output device 1 in that the memory unit 11 has a frequency masking sound FM and a temporal masking sound TM stored therein. Since there is no other difference between the sound output devices 1 and 6, components in FIG. 6 that correspond to those in FIG. 1 are denoted by the same reference numerals, and any descriptions thereof will be omitted.

The frequency masking sound FM is similar to the masking sound M in the first embodiment, and therefore any description thereof will be omitted.

As with the masking sound M in the first embodiment, the temporal masking sound TM is created on the basis of an operation sound obtained through experiments by the supplier (manufacturer). Specifically, as described in the first embodiment, the operation sound includes some portion where its sound pressure level unexpectedly increases, for example, due to collision noise produced by a recording medium. To subject such a portion to temporal masking, the temporal masking sound TM is generated, for example, by processing a BGM, an environmental sound, etc., so as to include portions whose sound pressure levels are higher in the forward and backward directions in time than portions of the operation sound that are at high sound pressure levels. The sound output unit 13 outputs the temporal masking sound TM, in place of the BGM α in the first embodiment, under control of the sound reproducing unit 12.

### Actions and Effects of Second Embodiment

In the present embodiment, since the frequency masking sound FM is outputted from the sound output unit 13 acting as an example of a first masking sound output unit, the operation sound (noise) of the image forming apparatus 2 can be reduced. Moreover, since the temporal masking sound TM is outputted from the sound output unit 13 acting as an example of a second masking sound output unit, any sudden loud operation sound (noise) is made inaudible to the user. Furthermore, since the temporal masking sound TM is created on the basis of a BGM and an environmental sound, the user's attention is drawn more by the temporal masking sound TM than by the frequency masking sound FM. Thus, as in the first embodiment, the frequency masking sound FM can be rendered less annoying.

Note that the memory unit 11 may have stored therein a plurality of frequency masking sounds FM and a plurality of temporal masking sounds TM.

Although the present invention has been described in connection with the preferred embodiment above, it is to be noted that various changes and modifications are possible to those who are skilled in the art. Such changes and modifications are to be understood as being within the scope of the invention.

What is claimed is:

1. A sound output device for masking an operation sound generated by equipment, comprising:
a BGM output unit that outputs a BGM; and
a masking sound output unit that outputs a masking sound after the BGM output unit outputs the BGM.

2. The sound output device according to claim 1, wherein,
the masking sound is generated so as to mask as a noise an operation sound generated during a predetermined action of the equipment, and
the masking sound output unit outputs the masking sound before the predetermined action starts.

3. The sound output device according to claim 1, wherein the BGM or the masking sound gradually increases in output sound pressure level after its output starts.

4. The sound output device according to claim 1, wherein,
the masking sound output unit stops outputting the masking sound after the predetermined action ends, and
the BGM output unit stops outputting the BGM after the outputting of the masking sound stops.

5. The sound output device according to claim 1, wherein the output sound pressure level of the BGM is higher than the output sound pressure level of the masking sound.

6. The sound output device according to claim 1, wherein,
the masking sound is generated so as to mask as a noise an operation sound generated during a predetermined action of the equipment, and
the timing of starting output of the masking sound or the degree of change in output volume of the masking sound is controlled on the basis of a period of time from the equipment starting an operation until noise generation.

7. The sound output device according to claim 1, wherein,
the masking sound is generated so as to mask as a noise an operation sound generated during a predetermined action of the equipment, and
the equipment performs the predetermined action after a lapse of a predetermined period of time once output of the masking sound starts.

8. The sound output device according to claim 1, wherein,
the masking sound is generated so as to mask as a noise an operation sound generated during a predetermined action of the equipment, and
when the equipment starts operating while the BGM output unit is outputting the BGM, the masking sound output unit outputs the masking sound before the predetermined action starts.

9. The sound output device according to claim 1, further comprising;
a memory unit having stored therein the BGM in plurality; and
a sound reproducing unit that selects a BGM from the memory unit and causing the BGM output unit to output the BGM.

10. The sound output device according to claim 1, wherein the equipment is an image forming apparatus.

11. The sound output device according to claim 1, wherein the equipment is peripheral equipment of an image forming apparatus.

12. A sound output device for masking an operation sound generated by equipment, comprising:
a first masking sound output unit that outputs a temporal masking sound; and
a second masking sound output unit that outputs a frequency masking sound after the first masking sound output unit outputs the temporal masking sound.
